(19) United States
(12) Patent Application Publication
(10) Pub. No.: US 2026/0296447 A1
(43) Pub. Date: Oct. 1, 2026

(54) SYSTEMS AND METHODS TO UPDATE BASELINE DRIVING

(71) Applicant: TOYOTA MOTOR ENGINEERING & MANUFACTURING NORTH AMERICA, INC., Plano, TX (US)

(72) Inventors: Seyhan UCAR, Mountain View, CA (US); Emrah Akin SISBOT, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 19/092,754

(22) Filed: Mar. 27, 2025

(51) Int. Cl. B60W 40/09; B60W 40/08; G06V 20/59; H04W 4/46

(52) U.S. Cl. CPC B60W 40/09; G06V 20/597; H04W 4/46; B60W 2040/0818

(57) ABSTRACT

Systems and methods are provided for updating baseline driving. The system can obtaining a plurality of baseline driving levels from a driving anomaly detection system and also receive data associated with a potential driving anomaly. The system can determine that the potential driving anomaly is associated with a baseline driving condition and update the plurality of baseline driving levels based on the potential driving anomaly.

### TECHNICAL FIELD

The present disclosure relates generally to evaluating unsafe driving, and in particular, some implementations may relate to updating baseline driving in autonomous, semi-autonomous, and manually driven vehicles.

### DESCRIPTION OF RELATED ART

Some driving systems analyze objects in a roadway in which the vehicle (e.g., the ego vehicle) is traveling. The objects may be moveable objects, like other vehicles and drivers, or immovable objects like traffic lights and stop signs. When an object is acting without regard to the expected procedure, the vehicle may determine that the object is an anomaly. The object may be an anomaly by performing actions that are done in an unusual time (e.g., relative to a typical time for a particular geographic location) or an unusual location (e.g., relative to a typical location). For example, a vehicle that is exhibiting anomalous behavior includes performing an unusual action that does not typically occur or infrequently occurs relative to the types of actions that are typical for a particular geographic location. An occurrence of a vehicle exhibiting anomalous behavior in a roadway environment may jeopardize safety of various roadway participants (e.g., vehicles, drivers, passengers, pedestrians, bikers, etc.) and may reduce the overall efficiency of a transportation system. There could be cases where drivers receive specific instructions, such as when police officers are directing traffic, or when an emergency situation arises that prompts drivers to act instinctively, like using a zipper merge to yield to an ambulance. Traditional unsafe driving detection methods may classify these behaviors as unsafe though the behavior may be appropriate for the specific situation. Conventional methodologies may adapt to these situations based on a threshold of repeated actions.

### BRIEF SUMMARY OF THE DISCLOSURE

According to various embodiments of the disclosed technology, a method can comprise obtaining a plurality of baseline driving levels from a driving anomaly detection system; receiving environmental data and event data associated with a potential driving anomaly; determining that the potential driving anomaly is associated with a baseline driving condition; and updating the plurality of baseline driving levels based on the potential driving anomaly.

In some embodiments, the method further comprises classifying the potential driving anomaly as periodic driving behavior or aperiodic driving behavior.

In some embodiments, the method further comprises analyzing image data obtained from one or more vehicles to determine driver attention associated with the potential driving anomaly; and determining that the potential driving anomaly is associated with the baseline driving condition based on the driver attention.

In some embodiments, the method further comprises comparing the potential driving anomaly to an event database storing the plurality of baseline driving levels.

In some embodiments, the method further comprises adding a new event into the event database based on determining that the potential driving anomaly is associated with the baseline driving condition.

In some embodiments, the updates to the plurality of baseline driving levels are applied for a discrete time interval.

In some embodiments, the method further comprises executing a feedback loop to update the plurality of baseline driving levels at a repeating time interval.

In some embodiments, the method further comprises transmitting updates to the plurality of baseline driving levels to a plurality of connected vehicles.

According to various embodiments of the disclosed technology, a vehicle can comprise a processor and a memory coupled to the processor to store instructions. The instructions, when executed by the processor, can cause the processor to obtain a plurality of baseline driving levels from a driving anomaly detection system; receive image data from one or more cameras, wherein the image data is associated with a potential driving anomaly; determine that the potential driving anomaly is associated with a baseline driving condition by analyzing the image data to determine driver attention associated with the potential driving anomaly; and update the plurality of baseline driving levels based on the driver attention.

In some embodiments, the instructions further cause the processor to classify the potential driving anomaly as periodic driving behavior or aperiodic driving behavior.

In some embodiments, the instructions further cause the processor to compare the potential driving anomaly to an event database storing the plurality of baseline driving levels.

In some embodiments, the instructions further cause the processor to add a new event into the event database based on determining that the potential driving anomaly is associated with the baseline driving condition.

In some embodiments, the updates to the plurality of baseline driving levels are applied for a discrete time interval.

In some embodiments, the instructions further cause the processor to execute a feedback loop to update the plurality of baseline driving levels at a repeating time interval.

In some embodiments, the instructions further cause the processor to transmit updates to the plurality of baseline driving levels to a plurality of vehicles connected to the vehicle.

According to various embodiments of the disclosed technology, a non-transitory machine-readable medium can have instructions stored therein. The instructions, when executed by a processor, can cause the processor to obtain a plurality of baseline driving levels from a driving anomaly detection system; receive environmental data and event data associated with a potential driving anomaly; determine that the potential driving anomaly is associated with a temporary baseline driving condition; and update the plurality of baseline driving levels based on the potential driving anomaly for a discrete time interval.

In some embodiments, the instructions further cause the processor to analyze image data obtained from one or more vehicles to determine driver attention associated with the potential driving anomaly; and determine that the potential driving anomaly is associated with the temporary baseline driving condition based on the driver attention.

In some embodiments, the instructions further cause the processor to compare the potential driving anomaly to an event database storing the plurality of baseline driving levels.

In some embodiments, the instructions further cause the processor to add a new event into the event database based on determining that the potential driving anomaly is associated with the temporary baseline driving condition.

In some embodiments, the instructions further cause the processor to transmit updates to the plurality of baseline driving levels to a plurality of connected vehicles.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for updating baseline driving in accordance with one embodiment of the systems and methods.

FIG. 3A illustrates an example system incorporating the architecture for updating baseline driving in accordance with one embodiment of the systems and methods described herein.

FIG. 3B illustrates an example environment incorporating the architecture for updating baseline driving.

FIG. 4 illustrates an example method for updating baseline driving in accordance with various embodiments.

FIG. 5 is an example computing component that may be used to implement various features of embodiments described in the present disclosure.

The figures are not exhaustive and do not limit the present disclosure to the precise form disclosed.

### DETAILED DESCRIPTION

Traditional systems for detecting unsafe driving can be incorporated at either the vehicle or remote server level. At the vehicle level, an ego vehicle or group of vehicles can monitor surrounding or nearby vehicles to determine “baseline driving.” Here, baseline driving refers to a typical or normal course of driving as applied to a vehicle, driver, location, or other group. Baseline driving can also refer to driving actions or movement patterns that consistently repeat in a given location or situation. These patterns can represent the typical behavior of drivers under similar conditions and serve as a baseline for detecting anomalies or deviations. An ego vehicle can determine a level of baseline driving and detect unsafe driving based on the baseline driving. Driving behavior can be classified based on similarities or differences to the level of baseline driving. At the remote server level, a remote server can collect observations from multiple vehicles. A remote server can similarly learn baseline driving and initiate unsafe driving detection.

As described above, traditional systems can trigger false positives that can lead to misunderstandings and misrepresentations of driver actions that are, in fact, appropriate responses to unique circumstances. Traditional systems often can take time to adjust to changes in baseline driving behavior and may require a specific threshold of repeated actions before they can be recognized. The systems and methods disclosed herein improve these traditional systems by updating baseline driving levels based on situational factors. The system can make adjustments for correlated elements such as the vehicles, sections, localities, and city to reduce false positives in unsafe driving detection. This can be accomplished by analyzing the surrounding information and adjusting the baseline driving accordingly. The system can communicate adjustments in real time with the correlated elements. This updated system can be executed by an ego vehicle, a group of vehicles that are connected or unconnected, and/or a remote server. The system can continuously monitor and update baseline driving through feedback loops.

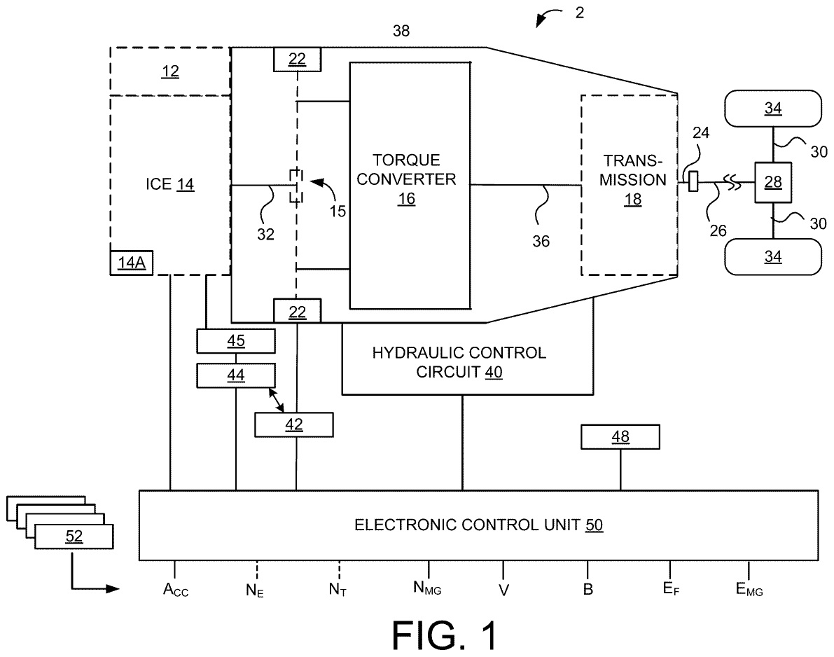

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods can be implemented in other types of vehicles including gasoline- or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+MG 12) efficiency, acceleration, ACC, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

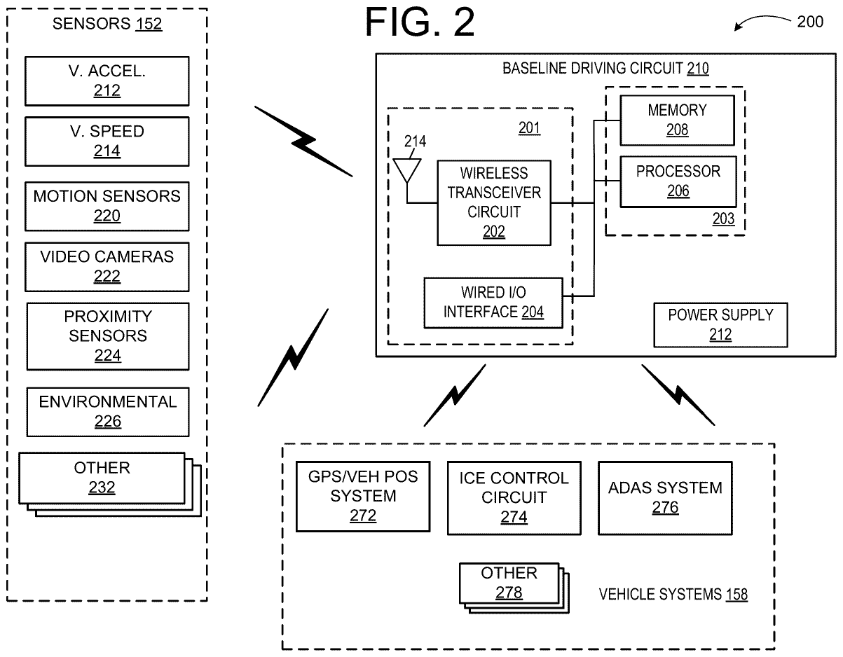

FIG. 2 illustrates an example architecture for updating baseline driving in accordance with one embodiment of the systems and methods described herein. Referring now to FIG. 2, in this example, baseline driving system 200 includes a baseline driving circuit 210, a plurality of sensors 152 and a plurality of vehicle systems 158. Sensors 152 and vehicle systems 158 can communicate with baseline driving circuit 210 via a wired or wireless communication interface. Although sensors 152 and vehicle systems 158 are depicted as communicating with baseline driving circuit 210, they can also communicate with each other as well as with other vehicle systems. Baseline driving circuit 210 can be implemented as an ECU or as part of an ECU such as, for example electronic control unit 50. In other embodiments, baseline driving circuit 210 can be implemented independently of the ECU.

Baseline driving circuit 210 in this example includes a communication circuit 201, a decision circuit 203 (including a processor 206 and memory 208 in this example) and a power supply 212. Components of baseline driving circuit 210 are illustrated as communicating with each other via a data bus, although other communication in interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to baseline driving circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up baseline driving circuit 210.

Communication circuit 201 either or both a wireless transceiver circuit 202 with an associated antenna 205 and a wired I/O interface 204 with an associated hardwired data port (not illustrated). As this example illustrates, communications with baseline driving circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by baseline driving circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which baseline driving system 200 is implemented. In the illustrated example, sensors 152 include vehicle acceleration sensors 212, vehicle speed sensors 214, motion sensors 220, video cameras 222, proximity sensors 224, and environmental sensors 226 (e.g., to detect salinity or other environmental conditions). Additional sensors 232 can also be included as may be appropriate for a given implementation of baseline driving system 200.

Vehicle systems 158 can include any of a number of different vehicle components or subsystems used to control or monitor various aspects of the vehicle and its performance. In this example, the vehicle systems 158 include a GPS or other vehicle positioning system 272; engine control circuits 274 to control the operation of engine (e.g. Internal combustion engine 14); advanced driver assistance system 276; and other vehicle systems 278.

During operation, baseline driving circuit 210 can receive information from various vehicle sensors to determine whether to update baseline driving. Communication circuit 201 can be used to transmit and receive information between baseline driving circuit 210 and sensors 152, and baseline driving circuit 210 and vehicle systems 158. Also, sensors 152 may communicate with vehicle systems 158 directly or indirectly (e.g., via communication circuit 201 or otherwise).

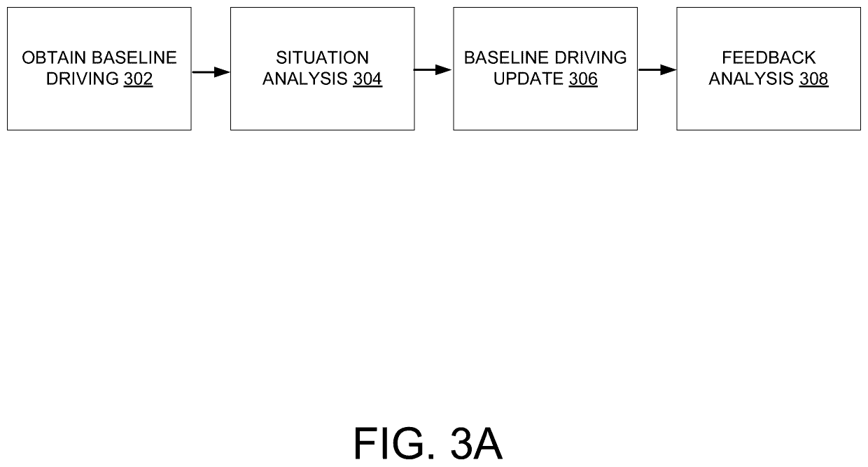

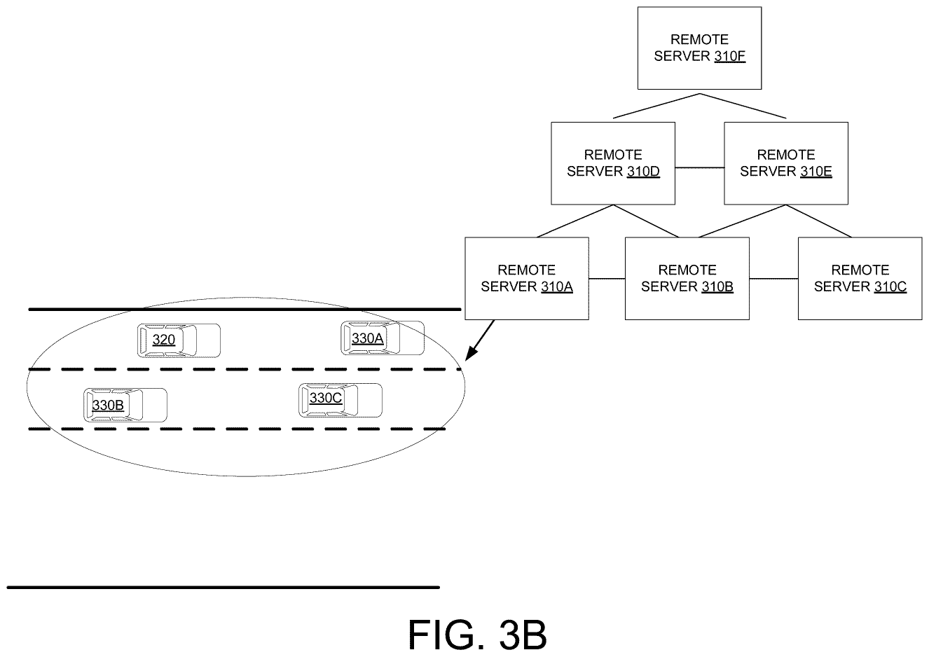

FIG. 3A illustrates an example system incorporating the architecture for updating baseline driving in accordance with one embodiment of the systems and methods described herein. At block 302, the system can obtain data on the current baseline driving levels. The baseline driving can be associated with particular infrastructure levels. For instance, there may be baseline driving levels applied for a particular city or geographic area. As described above, the system herein can obtain baseline driving data from various mechanisms, such as through time series analyses, machine learning models, and/or other methods. In systems executed by a remote server, the remote server can obtain information from multiple entities (vehicles, infrastructure elements, other remote servers, etc.) and can perform multivariate time series analyses to learn baseline driving at any level. The system can infer periodic and non-periodic driving behavior. For example, periodic baseline driving behavior can refer to repeating instances of behavior, such as stop and go traffic, stoplight behaviors, etc. Non-periodic driving behavior can refer to non-repeating or random events such as lane merges, starting and stopping points of traffic, or any other asynchronous driving events.

At block 304, the system can perform an event and environment analysis to update baseline driving levels. For example, at the vehicle level, the ego vehicle or other connected vehicle can analyze images from front and rear cameras to assess driver attention. The objects that capture a driver's attention can provide valuable insights into the surrounding environment or situation. As described above, the system can obtain data from infrastructure elements. The roadside infrastructure can be utilized to detect specific events or objects, such as a police car at an intersection prompting a left lane diversion to the right. The system can develop an event database with predefined key events and objects that inform baseline driving behavior. As an example, key objects can include large and interdependent entities, such as a truck with a trailer or a vehicle platoon that requires wider turns or additional space. In this example, surrounding vehicles may need to drift slightly out of their lanes to accommodate erratic movements from these larger vehicles. In some embodiments, machine learning models can identify and incorporate new events into the event database.

At block 306, the system can perform updates to the baseline driving levels. The system can identify instances where the retrieved baseline driving behavior does not align with the observed behavior. In some embodiments, a misalignment can be determined based on a threshold number of vehicles exhibiting the same driving behaviors. The system can determine whether this driving behavior is a repeating movement pattern based on the detected key events. In some embodiments, the system can determine whether the driver is engaged in an event listed in the event database. For example, a police officer may redirect traffic to a different lane, causing the ego vehicle to decelerate. This sudden deceleration can trigger the system as this driving behavior does not match the baseline driving levels. The system can obtain the environmental data to identify an object in the road (i.e., the police officer) and determine that the driver is paying attention to the police officer. Instead of tagging the driving behavior as unsafe, the system can update the baseline driving levels to indicate that the deceleration is within safe driving behavior due to the situation. The updated baseline driving can have a shorter-term interval because the officer will likely not redirect traffic permanently. Short term updates may be associated with more frequent updates and monitoring from the system to determine when the update is no longer applicable. As another example, an update may be considered “dynamic”, which can indicate a range of potential behavior changes. The dynamic indication can also inform the system that the key elements causing the behavior may change. In some embodiments, the baseline driving may be tagged along with a specific key object. For example, a repeated driving maneuver may be associated with a moving ambulance. Because the ambulance is constantly moving, the baseline driving should move geographically with the ambulance. At block 308, the system can run feedback loops as necessary to continuously update the baseline driving update system. As described above, in some embodiments, machine learning models can identify and incorporate new events into the event database on a periodic or aperiodic basis. In some embodiments, the system may also evaluate current events in the event database to determine accuracy and applicability. In some embodiments, the feedback loops can allow the system to identify key events corresponds particular instances of baseline driving behavior. These key events can be accordingly added to the event database.

FIG. 3B illustrates an example environment incorporating the architecture for updating baseline driving. In the example of FIG. 3B, the system can be executed by vehicles 330A-C. As described above, one vehicle can execute the baseline driving system or multiple vehicles may work in tandem. In some embodiments, vehicles 330A-C may be connected or not connected, i.e., through V2X communication. Vehicle 320 illustrates a vehicle that is operating outside of baseline driving behavior. As described above, the system can determine through an event database that vehicle 320 is operating differently. Vehicles 330A-C can execute the system to determine if the behavior is unsafe driving behavior or if the baseline driving need to be updated. FIG. 3B also illustrates multiple remote servers 310A-F. Remote servers 310A-F may be located on different locality levels, i.e., city, state, etc. Remote servers 310A-F may also execute the baseline driving update system or can transmit information to one or more of vehicles 330A-C so that the vehicles can update the baseline driving levels.

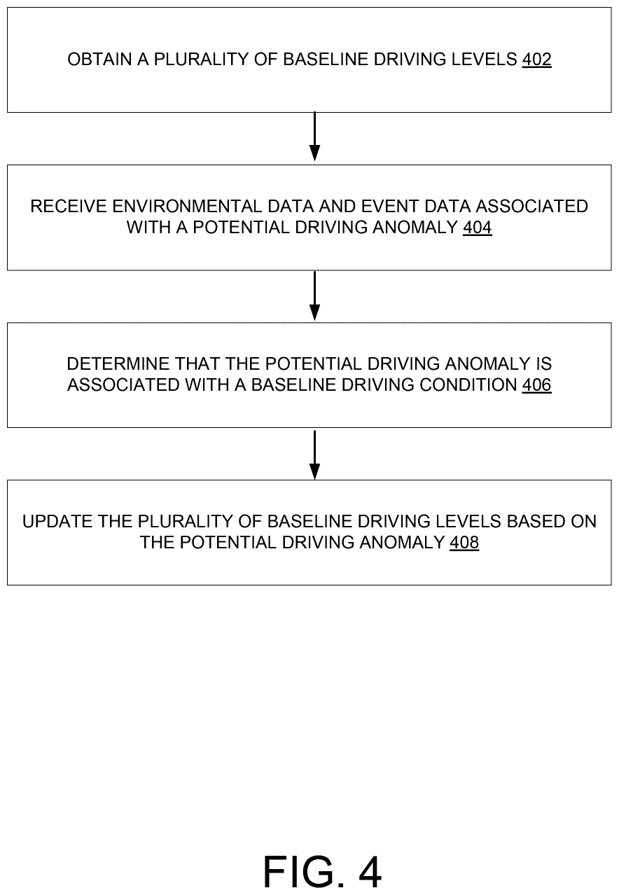

FIG. 4 illustrates an example method for updating baseline driving in accordance with various embodiments. At block 402, a plurality of baseline driving levels can be obtained from a driving anomaly detection system. As described above, the system can obtain baseline driving data from various mechanisms, such as through time series analyses, machine learning models, and/or other methods. In systems executed by a remote server, the remote server can obtain information from multiple entities (vehicles, infrastructure elements, other remote servers, etc.) and can perform multivariate time series analyses to learn baseline driving at any level.

At block 404, the system can receive environmental data and event data associated with a potential driving anomaly. As described above, at the vehicle level, an ego vehicle or other connected vehicle can analyze images from front and rear cameras to assess driver attention. In some embodiments, the system can obtain data from infrastructure elements. In some embodiments, the system can develop an event database with predefined key events and objects that inform baseline driving behavior. In some embodiments, new events can be incorporated into the event database.

At block 406, the system can determine that the potential driving anomaly is associated with a baseline driving condition. The system can identify instances where the retrieved baseline driving behavior does not align with the observed behavior. In some embodiments, the system can determine whether the driver is engaged in an event listed in the event database. In some embodiments, the updated baseline driving can have a discrete time interval if the change to the baseline driving is temporary. Short term updates may be associated with more frequent updates and monitoring from the system to determine when the update is no longer applicable.

At block 408, the system can update the plurality of baseline driving levels based on the potential driving anomaly. Some embodiments can execute feedback loops as necessary to continuously update the baseline driving update system at one or more repeated time intervals. As described above, one vehicle can execute the baseline driving system or multiple vehicles may work in tandem. Remote servers may also execute the baseline driving update system or can transmit information and updates to other connected vehicles so that other vehicles can update the baseline driving levels.

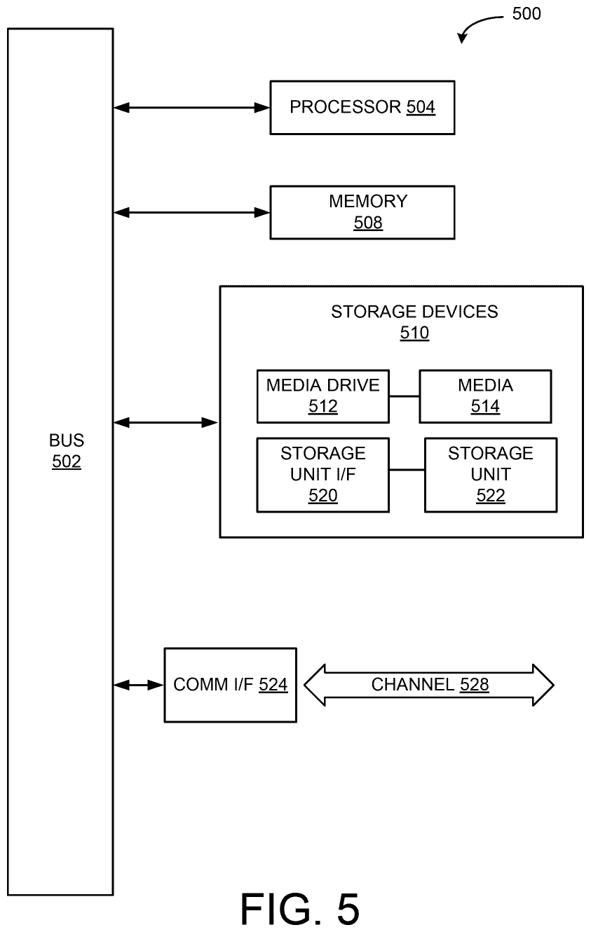

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining a plurality of baseline driving levels from a driving anomaly detection system;
receiving environmental data and event data associated with a potential driving anomaly;
determining that the potential driving anomaly is associated with a baseline driving condition; and
updating the plurality of baseline driving levels based on the potential driving anomaly.

2. The method of claim 1, further comprising classifying the potential driving anomaly as periodic driving behavior or aperiodic driving behavior.

3. The method of claim 1, further comprising:
analyzing image data obtained from one or more vehicles to determine driver attention associated with the potential driving anomaly; and
determining that the potential driving anomaly is associated with the baseline driving condition based on the driver attention.

4. The method of claim 1, further comprising comparing the potential driving anomaly to an event database storing the plurality of baseline driving levels.

5. The method of claim 4, further comprising adding a new event into the event database based on determining that the potential driving anomaly is associated with the baseline driving condition.

6. The method of claim 1, wherein the updates to the plurality of baseline driving levels are applied for a discrete time interval.

7. The method of claim 1, further comprising executing a feedback loop to update the plurality of baseline driving levels at a repeating time interval.

8. The method of claim 1, further comprising transmitting updates to the plurality of baseline driving levels to a plurality of connected vehicles.

9. A vehicle, comprising:
a processor; and
a memory coupled to the processor to store instructions, which when executed by the processor, cause the processor to:
obtain a plurality of baseline driving levels from a driving anomaly detection system;
receive image data from one or more cameras, wherein the image data is associated with a potential driving anomaly;
determine that the potential driving anomaly is associated with a baseline driving condition by analyzing the image data to determine driver attention associated with the potential driving anomaly; and
update the plurality of baseline driving levels based on the driver attention.

10. The vehicle of claim 9, wherein the instructions further cause the processor to classify the potential driving anomaly as periodic driving behavior or aperiodic driving behavior.

11. The vehicle of claim 9, wherein the instructions further cause the processor to compare the potential driving anomaly to an event database storing the plurality of baseline driving levels.

12. The vehicle of claim 11, wherein the instructions further cause the processor to add a new event into the event database based on determining that the potential driving anomaly is associated with the baseline driving condition.

13. The vehicle of claim 9, wherein the updates to the plurality of baseline driving levels are applied for a discrete time interval.

14. The vehicle of claim 9, wherein the instructions further cause the processor to execute a feedback loop to update the plurality of baseline driving levels at a repeating time interval.

15. The vehicle of claim 9, wherein the instructions further cause the processor to transmit updates to the plurality of baseline driving levels to a plurality of vehicles connected to the vehicle.

16. A non-transitory machine-readable medium having instructions stored therein, which when executed by a processor, cause the processor to:
obtain a plurality of baseline driving levels from a driving anomaly detection system;
receive environmental data and event data associated with a potential driving anomaly;
determine that the potential driving anomaly is associated with a temporary baseline driving condition; and
update the plurality of baseline driving levels based on the potential driving anomaly for a discrete time interval.

17. The non-transitory machine-readable medium of claim 16, wherein the instructions further cause the processor to:
analyze image data obtained from one or more vehicles to determine driver attention associated with the potential driving anomaly; and
determine that the potential driving anomaly is associated with the temporary baseline driving condition based on the driver attention.

18. The non-transitory machine-readable medium of claim 16, wherein the instructions further cause the processor to compare the potential driving anomaly to an event database storing the plurality of baseline driving levels.

19. The non-transitory machine-readable medium of claim 18, wherein the instructions further cause the processor to add a new event into the event database based on determining that the potential driving anomaly is associated with the temporary baseline driving condition.

20. The non-transitory machine-readable medium of claim 16, wherein the instructions further cause the processor to transmit updates to the plurality of baseline driving levels to a plurality of connected vehicles.
